(19) United States
(12) Patent Application Publication
(10) Pub. No.: US 2008/0079526 A1
(43) Pub. Date: Apr. 3, 2008

(54) LIGHT TUBE DRIVING CIRCUIT AND TRANSFORMER THEREOF

(75) Inventors: Ching-Fu Hsueh, Taoyuan County (TW); Wen-Hsien Chen, Hsinchu County (TW); Wan-Chin Hsu, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DARFON ELECTRONICS CORP., Taoyuan (TW)

(21) Appl. No.: 11/949,096

(22) Filed: Dec. 3, 2007

Related U.S. Application Data
(62) Division of application No. 11/343,293, filed on Jan. 30, 2006.

(30) Foreign Application Priority Data
Feb. 5, 2005 (TW) 94104121

(51) Int. Cl. H01F 27/29

(52) U.S. Cl. 336/192

(57) ABSTRACT

A transformer includes a bobbin, a primary coil, a first secondary coil, a first core, a second core and a third core. The bobbin has a through hole. The primary coil and the first secondary coil are respectively surrounded on the bobbin. The first core is embedded into the through hole. The second core is coupled to the first core to form a magnetic loop. The third core is coupled to the first core and the second core and located between the primary coil and the first secondary coil. The third core having high impedance is fastened on the second core or the bobbin alternatively. A light tube driving circuit with the above transformer drives a discharge lamp.

### CROSS REFERENCE TO RELATED APPLICATIONS

This application is a Divisional of pending U.S. patent application serial number 11/343,293, filed Jan. 13, 2006 and entitled “LIGHT TUBE DRIVING CIRCUIT AND TRANSFORMER THEREOF,” incorporated herein by reference.

### BACKGROUND OF THE INVENTION

1. Field of the Invention

The invention relates in general to a transformer, and more particularly to a transformer using a third core with high impedance to increase a magnetic flux and a leakage inductance.

2. Description of the Related Art

With the coming of the multimedia age, applications of liquid crystal displays (LCDs) in, for example, computer monitors, LCD televisions and the like, have gradually grown wider and wider. In general, the LCD uses a light-weighted discharge lamp having a high efficiency as a light source of a backlight module, and thus has the features of the thin thickness and the clear and stable image quality.

The backlight module in the LCD is mainly composed of a CCFL (Cold Cathode Fluorescent Lamp) discharge lamp, and a transformer for driving the CCFL. FIG. 1 is a schematically exploded view showing a conventional transformer 100. Referring to FIG. 1, the transformer 100 has a bobbin 101, a first core 103, a second core 105, a primary coil 107 and a secondary coil 109. After the transformer 100 is powered on, the magnetic flux flows from one end 105a of the second core 105 to the other end 105b of the second core 105, then from the other end 105b to one end of the first core 103, and then back to the second core 105.

However, the stray capacitor effect between the CCFL and the casing of the LCD often occurs, and the stray capacitor effect causes differences between the currents of different CCFLs in the LCD and thus influences the current stability. When the currents flowing through the CCFLs are different, the CCFLs generate different luminances such that the luminance of the backlight module is nonuniform. In addition, the brighter CCFL has the shorter lifetime. In order to obtain the current stability, the manufacturer has to dispose one high-voltage capacitor between each CCFL and the secondary coil so as to reduce the influence of the stray capacitor and thus the differences between the currents of different CCFLs. However, the cost of these high-voltage capacitors is very high.

In addition, the voltage difference between the primary coil and the secondary coil in many transformers is very high, which tends to form the flashover between the core and each wire of the primary coil and the secondary coil.

### SUMMARY OF THE INVENTION

It is therefore an object of the invention to provide a transformer, which has a reduced number of high-voltage capacitors or has no high-voltage capacitor in a discharge lamp driving circuit due to the increased magnetic flux so as to control the current stability and prevent the transformer from being burnt out due to the flashover formed between the primary coil and a secondary coil.

The invention achieves the above-identified object by providing a transformer including a bobbin, a primary coil, a first secondary coil, a first core, a second core and a third core. The bobbin has a through hole. The primary coil and the first secondary coil are respectively surrounded on the bobbin. The first core is embedded into the through hole. The second core coupled to the first core has a first end and a second end respectively disposed at two ends of the first core. The third core having high impedance is located between the primary coil and the first secondary coil, and may be alternatively fastened on the second core or the bobbin. The third core and the first core are distant from each other by a specific distance.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematically exploded view showing a conventional transformer.

FIG. 2A is a pictorial view showing a transformer according to a first embodiment of the invention.

FIG. 2B is a top view showing the transformer of the first embodiment.

FIG. 2C is a schematic illustration showing lines of magnetic force in the transformer of the first embodiment.

FIG. 3A is a pictorial view showing a transformer according to a second embodiment of the invention.

FIG. 3B is a top view showing the transformer of the second embodiment.

FIG. 3C is a schematic illustration showing lines of magnetic force in the transformer of the second embodiment.

FIG. 4A is a pictorially exploded view showing a transformer according to a third embodiment of the invention.

FIG. 4B is a pictorially assembled view showing the transformer of the third embodiment.

FIG. 5 is a circuit diagram showing a light tube driving circuit according to a fourth embodiment of the invention.

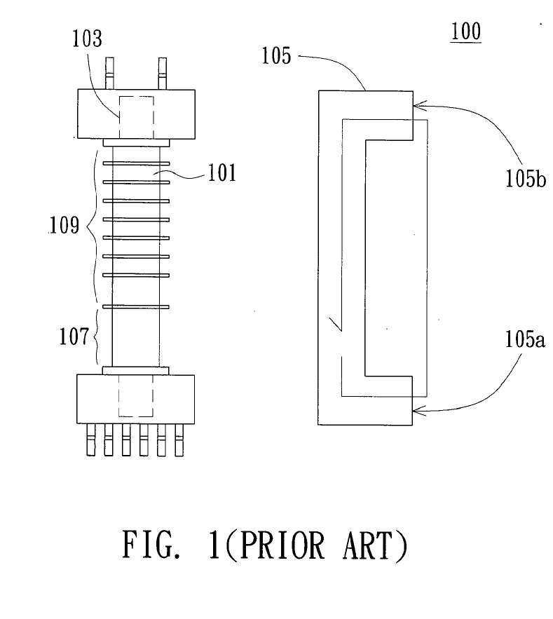

### DETAILED DESCRIPTION OF THE INVENTION

### First Embodiment

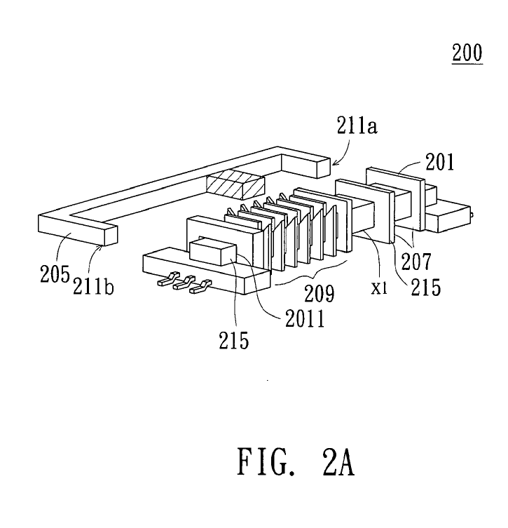

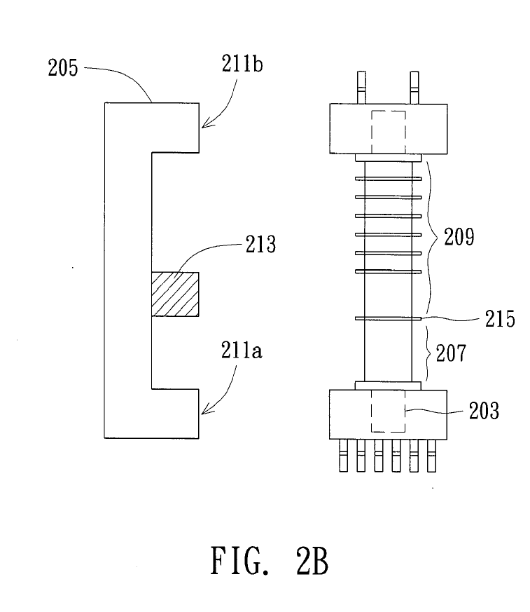

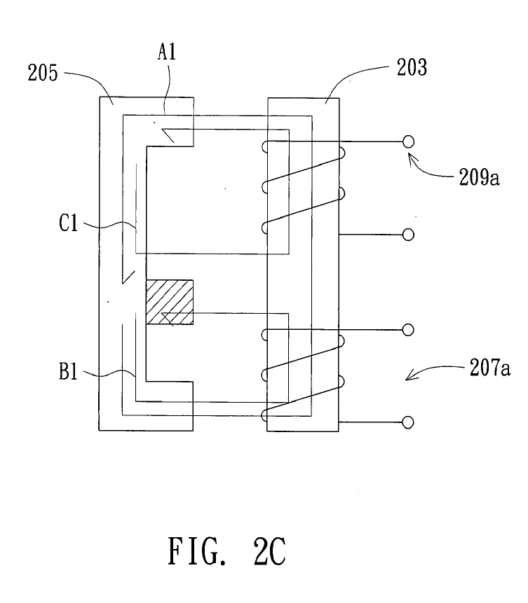

FIG. 2A is a pictorial view showing a transformer 200 according to a first embodiment of the invention. FIG. 2B is a top view showing the transformer of the first embodiment. Referring to FIGS. 2A to 2C. The transformer 200 includes a bobbin 201, a primary coil 207a, a first secondary coil 209a, a first core 203, a second core 205, a third core 213 and a first wall 215. The primary coil 207a and the first secondary coil 209a are respectively located in a first region 207 and a second region 209. A first space X1 exists between the first region 207 and the second region 209. The bobbin 201 has a through hole 2011, into which the first core 203 is placed and embedded. The second core 205 is coupled to the first core 203 to form a magnetic loop. The second core 205 has a first end 211a and a second end 211b respectively disposed at two ends of the first core 203. The third core 213 is coupled to the first core 203 and the second core 205 and located in the first space X1 between the primary coil 207a and the first secondary coil 209a. The third core 213 can be alternatively fastened on the second core 205 or fastened in the first space X1 of the bobbin 201. In this embodiment, the third core 213 is adhered between the first end 211a and the second end 211b of the second core using an adhesive and accommodated in the first space X1. The third core 213 is distant from the first core by a specific distance d (not shown), which is typically the thickness of the bobbin 201. The first wall 215 is disposed between the first region 207 and the first space X1.

FIG. 2C is a schematic illustration showing lines of magnetic force in the transformer of the first embodiment. When a voltage is applied to the primary coil 207a such that a current flows into the primary coil 207a, the primary coil 207a produces a magnetic flux AI, which makes the first secondary coil 209a generate an induced voltage and an induced current. The main magnetic flux A1 generated by the primary coil 207a and the first secondary coil 209a surrounds between the first core 203 and the second core 205. The direction of lines of magnetic force of the magnetic flux goes from the second core 205 to the first core 203 and finally back to the second core 205 to form a magnetic loop.

This embodiment uses the third core 213 with high impedance such that partial magnetic fluxes B1 and C1 are generated between the first core, the second core and the third core, and the total magnetic flux of the transformer is A1+B1+C1. This embodiment can effectively increase the magnetic flux so as to enhance the efficiency of the transformer. In addition, the third core 213 damages the mutual induction between the primary coil and the secondary coil, and the leakage inductance of each of the primary coil and the secondary coil is increased. Some driving circuits may request a transformer with a higher leakage inductance in order to meet the above-mentioned demand.

The transformer with the high leakage inductance may be applied to a stray capacitor for compensating a CCFL. when the secondary coil is electrically connected to the corresponding CCFL to drive the CCFL, the leakage inductors are coupled to the stray capacitor. Although the capacitances of the stray capacitors corresponding to the CCFLs in the backlight module are different, the inductances of the leakage inductors corresponding to the CCFLs are almost the same because the reactance of the equivalent inductor of the leakage inductance is greater than the reactance of the stray capacitor. Thus, the inductance of the leakage inductor corresponding to each CCFL and the overall equivalent reactance of the stray capacitor are almost the same. Consequently, it is unnecessary to conventionally use a high-voltage capacitor with the large capacitance to compensate the stray capacitor when the transformer of this embodiment is used. The leakage inductor makes the equivalent reactances viewed from each CCFL be almost the same, such that each CCFL generates substantially the same current. Consequently, using the transformer of this embodiment can eliminate the use of the high-voltage capacitor, reduce the cost and further enable the CCFLs to generate substantially the same luminance and to enhance the uniformity of the backlight module. In addition, the lifetime of each CCFL can be lengthened because the CCFLs have almost the same luminance.

In addition, the first core and the second core of the first embodiment is made of the manganese-zinc alloy, and the third core is made of the alloy material, preferably the nickel-zinc alloy, with high impedance. Because the nickel-zinc alloy has the high impedance (usually greater than 1 M Ohms), it is possible to prevent the problem of flashover caused by a too-great potential difference between the primary coil 207a and the first secondary coil 209a.

In the first embodiment, the second core preferably has a U-shape, and the first core 203 preferably has an I-shape. In addition, the first and second cores are not limited to the UI-shape structure but may have the EE, UU, LL, EI and UT structures.

### Second Embodiment

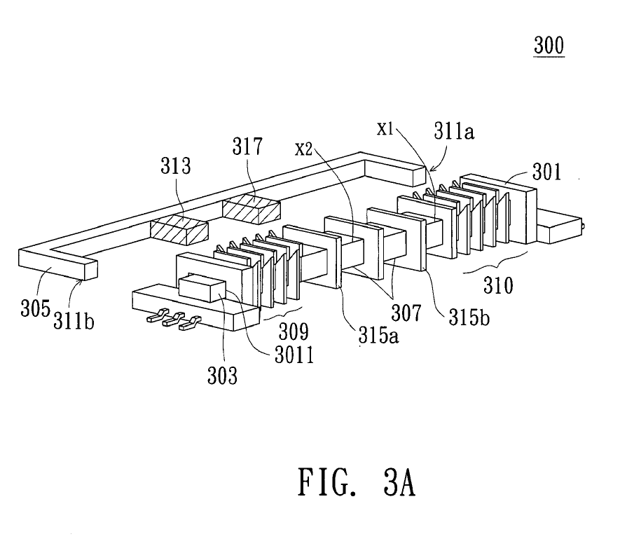

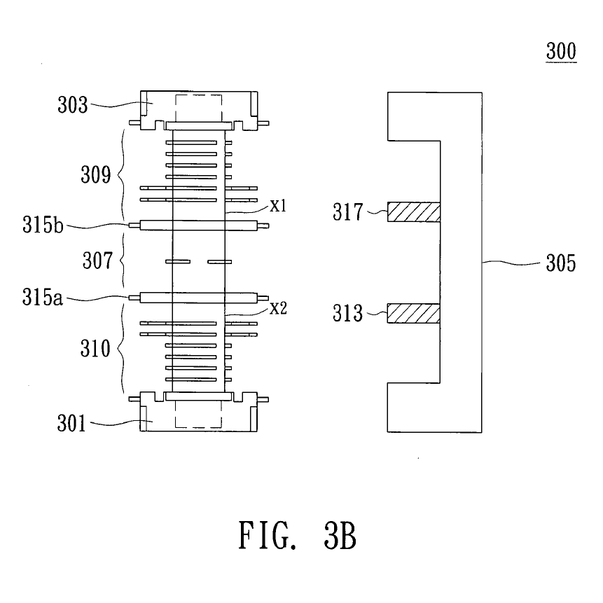

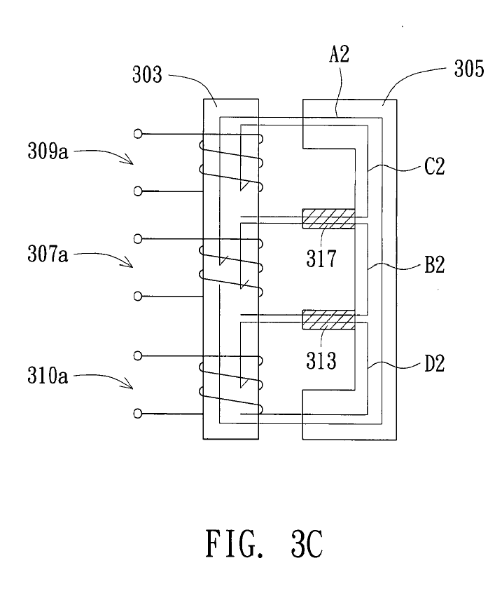

FIG. 3A is a pictorial view showing a transformer 300 according to a second embodiment of the invention. FIG. 3B is a top view showing the transformer of the second embodiment. Referring to FIGS. 3A to 3C, the transformer 300 includes a bobbin 301, a primary coil 307a, a first secondary coil 309a, a first core 303, a second core 305 and a first wall 315a. The transformer 300 further includes a second secondary coil 310a, a second wall 315b, a third core 313 and a fourth core 317. The third core 313 and the fourth core 317 and the third core of the first embodiment have the same function. The primary coil 307a, the first secondary coil 309a and the second secondary coil 310a are respectively located in a first region 307, a second region 309 and a third region 310. The primary coil 307a is located between the first secondary coil 309a and the second secondary coil 310a. A first space X1 exists between a first wall 315b and the first secondary coil 309a, and a second space X2 exists between the second wall 315b and the second secondary coil 310a. The fourth core 317 and the third core 313 are respectively disposed in the first space X1 and the second space X2. The fourth core 317 and the third core 313 are respectively coupled to the first core 303 and the second core 305, and the third core 313 and the fourth core 317 is distant from the first core 303 by a specific distance d (not shown), which is typically the thickness of the bobbin. The third core 313 and the fourth core 317 may be alternatively fastened on the second core 305 or the bobbin 301. In this embodiment, the third core 313 and the fourth core 317 are fastened on the second core 305 using an adhesive, and are respectively located in the first space X1 and the second space X2.

FIG. 3C is a schematic illustration showing lines of magnetic force in the transformer of the second embodiment. When a current flows into the primary coil 307a, the primary coil 307a generates a magnetic flux. The total magnetic flux is (A2+B2+C2+D2).

In the first embodiment, a third core is disposed in the primary coil and the first secondary coil. In the second embodiment, a third core and a fourth core are respectively disposed between the primary coil and the secondary coil in order to increase the magnetic flux and the leakage inductance. In the condition when the leakage inductance is increased, the wire of the coil can be properly enlarged such that the coil can withstand a higher power, the lamp temperature can be lowered, and the lifetime can be lengthened.

Similar to the first embodiment, the third core 313 and the fourth core 317 are made of a high impedance alloy, preferably the nickel-zinc alloy, in the second embodiment.

### Third Embodiment

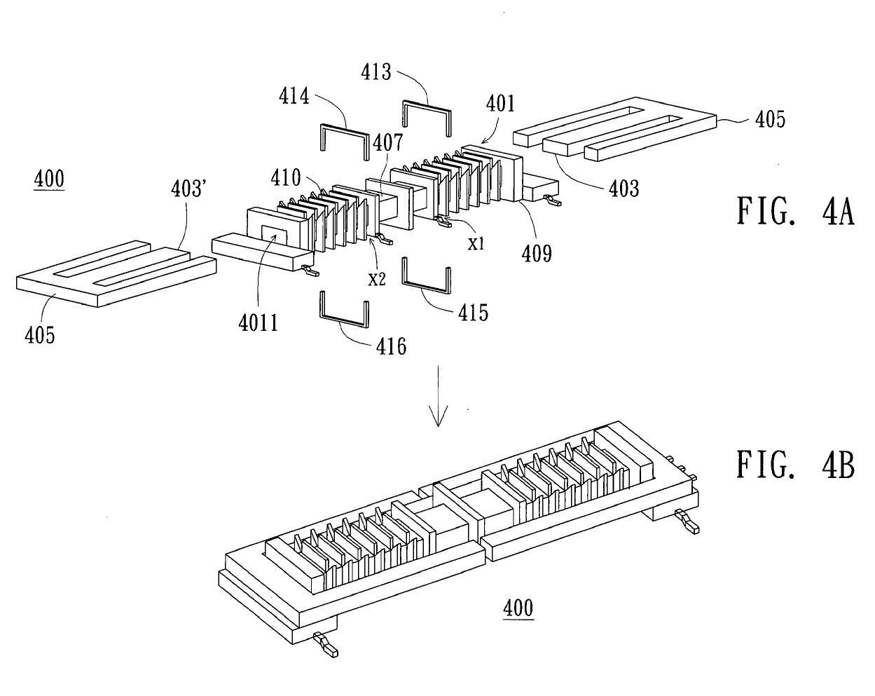

FIG. 4A is a pictorially exploded view showing a transformer according to a third embodiment of the invention. FIG. 4B is a pictorially assembled view showing the transformer of the third embodiment. The difference between the third and second embodiments resides in the arrangement of the first to third cores. Thus, the drawings of the primary coil and the secondary coil are omitted in FIGS. 4A and 4B. As shown in FIGS. 4A and 4B, a first core 403 is divided into two parts (403′) and embedded into a through hole 4011 of a bobbin 401. The primary coil is wound in a first region 407, and the second secondary coil and the first secondary coil are respectively wound in a second region 409 and a third region 410. In this embodiment, a fifth core 413, a sixth core 414, a seventh core 415 and an eighth core 416 with the same function are utilized. The fifth core 413 and the seventh core 415 opposite to each other in a vertical direction are disposed between the primary coil (not shown) and the first secondary coil (not shown), and the fifth core 413 and the seventh core 415 are respectively embedded into the first space X1 of the bobbin. Similarly, the sixth core 414 and the eighth core 416 opposite to each other in the vertical direction are disposed between the primary coil and the second secondary coil (not shown), and the sixth core 414 and the eighth core 416 are respectively embedded into a second space X2 of the bobbin. The function of the fifth to eighth cores (413 to 416) corresponds to that of the third and fourth cores (313, 317) in the second embodiment.

In the third embodiment, the first core 403 and the second core 405 are composed of two E-shape cores to form a magnetic loop, and may also be composed of one of the EI, UI, UU, UT and LL shaped cores to form a magnetic loop. These applications are well known in the art, and detailed descriptions thereof will be omitted.

### Fourth Embodiment

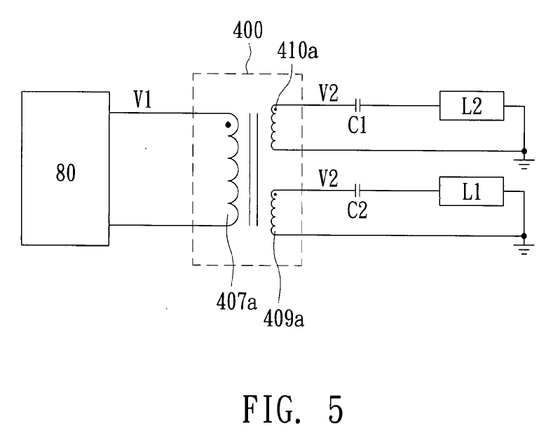

FIG. 5 is a circuit diagram showing a light tube driving circuit according to a fourth embodiment of the invention. Referring to FIG. 5, the light tube drive driving circuit includes a transformer 400 of the third embodiment, a driving circuit 80, a first lamp L1, a second lamp L2 and capacitors C1 and C2. The driving circuit 80 provides a low-voltage signal V1 to a primary coil 407a of the transformer to enable a first primary coil 409a and a second secondary coil 410a of the transformer to generate a high-voltage signal V2. The first and second lamps are respectively coupled to the ends of the first primary coil 409a and the second secondary coil 410a, both of which have the same polarity and are marked by “ ”. The first lamp L1 and the second lamp L2 are driven by the high-voltage signal V2. If the currents flowing through the first lamp L1 and the second lamp L2 are requested to be balanced (the same), the numbers of loops of the wires of the first secondary coil and the second secondary coil have to be substantially the same. The first and the second lamp are discharge lamps, and are preferably CCFLs.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A transformer adapted to a light tube driving circuit, the transformer comprising:
a bobbin having a through hole;
a primary coil and a first secondary coil respectively surrounded on the bobbin;
a first core embedded into the through hole;
a second core coupled to the first core to form a magnetic loop with the first core;
a third core coupled to the first core and the second core and located between the primary coil and the first secondary coil, wherein the third core has high impedance; and
a second secondary coil, wherein the primary coil is located between the first secondary coil and the second secondary coil.

2. The transformer according to claim 1, further comprising a fourth core located between the primary coil and the second secondary coil.

3. The transformer according to claim 1, further comprising a fifth core, a sixth core, a seventh core and an eighth core, wherein the fifth and seventh cores are embedded between the primary coil and the first secondary coil, and the sixth and eighth cores are embedded between the primary coil and the second secondary coil.

4. The transformer according to claim 3, wherein the fifth and seventh cores are embedded into the bobbin by way of opposite jointing, and the sixth and eighth cores are embedded into the bobbin by way of opposite jointing.

5. The transformer according to claim 3, wherein the fifth core, the sixth core, the seventh core and the eighth core have a U-shape.

6. A light tube driving circuit, comprising:
a bobbin having a through hole;
a primary coil and a first secondary coil respectively surrounded on the bobbin;
a first core embedded into the through hole;
a second core coupled to the first core to form a magnetic loop with the first core;
a third core coupled to the first core and the second core and located between the primary coil and the first secondary coil; and
a first lamp coupled to the first secondary coil, wherein the third core has high impedance.

7. The circuit according to claim 6, wherein the third core is a nickel-zinc alloy.

8. The circuit according to claim 6, wherein the third core is fastened on the second core using an adhesive.

9. The circuit according to claim 6, wherein the third core is embedded into the bobbin.

10. The circuit according to claim 6, wherein impedance of the nickel-zinc alloy is greater than 1 M Ohms.

11. The circuit according to claim 6, further comprising a second secondary coil and a second lamp, wherein the primary coil is located between the first secondary coil and the second secondary coil and the second lamp is coupled to the second secondary coil.

12. The circuit according to claim 6, further comprising a fourth core located between the primary coil and the second secondary coil.

13. The circuit according to claim 6, wherein the first core has an I-shape and the second core has a U-shape.

14. The circuit according to claim 11, further comprising a fifth core, a sixth core, a seventh core and an eighth core, wherein the fifth and seventh cores are embedded between the primary coil and the first secondary coil, and the sixth and eighth cores are embedded between the primary coil and the second secondary coil.

15. The circuit according to claim 14, wherein the fifth and seventh cores are embedded into the bobbin by way of opposite jointing and the sixth and eighth cores are embedded into the bobbin by way of opposite jointing.

16. The circuit according to claim 14, wherein the fifth core, the sixth core, the seventh core and the eighth core have a U-shape.

17. The circuit according to claim 6, wherein the first core and the second core are formed by one core of EE, EI, UI, UU, UT or LL.

18. A transformer adapted to a light tube driving circuit, the transformer comprising:
a bobbin having a through hole;
a first secondary coil and a second secondary coil respectively surrounded on the bobbin;
a primary coil surrounded on the bobbin and located between the first secondary coil and the second secondary coil;
a first core embedded into the through hole;
a second core coupled to the first core to form a magnetic loop with the first core; and
a third core and a fourth core, which are coupled to the first core and the second core and respectively located between the primary coil and the first secondary coil and between the primary coil and the second secondary coil, wherein each of the third core and the fourth core has high impedance.

19. The transformer according to claim 18, further comprising a fifth core and a sixth core, which are respectively located between the primary coil and the first secondary coil and between the primary coil and the second secondary coil, wherein the fifth core and the third core are oppositely embedded into the bobbin in a vertical direction, and the fourth core and the sixth core are oppositely embedded into the bobbin in the vertical direction.

20. The transformer according to claim 19, wherein each of the third core, the fourth core, the fifth core and the sixth core has a U-shape.

21. The transformer according to claim 19, wherein each of the third core, the fourth core, the fifth core and the sixth core is a nickel-zinc alloy.

22. The transformer according to claim 19, wherein the third core and the fourth core are embedded into the bobbin.
